(19) United States
(12) Patent Application Publication
(10) Pub. No.: US 2008/0167901 A1
(43) Pub. Date: Jul. 10, 2008

(54) Method of managing and providing healthcare

(75) Inventor: Robert B. Betz, Arlington, VA (US)

Correspondence Address: LITMAN LAW OFFICES, LTD., P.O. BOX 15035, CRYSTAL CITY STATION, ARLINGTON, VA, 22215, US

(73) Assignee: Caduceus Resource Administration, LLC

(21) Appl. No.: 12/003,720

(22) Filed: Dec. 31, 2007

Related U.S. Application Data
(60) Provisional application No. 60/883,827, filed on Jan. 8, 2007.

(51) Int. Cl. G06Q 50/00; G06Q 10/00

(52) U.S. Cl. 705/2

(57) ABSTRACT

The business method of managing and providing healthcare includes the formation of a centralized management organization for managing and organizing at least one group purchasing cooperative, formed from a plurality of members. Preferably, the plurality of members are selected from employers. Data and information related to the plurality of members is preferably stored and organized via a computerized system, and the group purchasing cooperative negotiates contracts directly with healthcare-related manufacturers and distributors for healthcare-related goods and services, in order to negotiate group benefits, such as discounts, rebates and the like. The goods and services may then be provided directly the members of the group purchasing cooperative.

### CROSS-REFERENCE TO RELATED APPLICATION

This application claims the benefit of U.S. Provisional Patent Application Ser. No. 60/883827, filed Jan. 8, 2007.

### BACKGROUND OF THE INVENTION

1. Field of the Invention

The present invention relates to a business method for managing and providing healthcare. Particularly, a management organization is formed for overseeing, managing and organizing a group purchasing cooperative. More particularly, the group purchasing cooperative negotiates contracts directly with healthcare-related manufacturers and distributors, with the group purchasing cooperative preferably being formed from members who are business employers.

2. Description of the Related Art

Group purchasing organizations (GPOs) are well known business methodologies and have been applied to many different types of businesses, such as healthcare providers, for example. A conventional healthcare-related GPO aids healthcare providers (e.g., hospitals, nursing homes, home health agencies, etc.) achieve savings and greater efficiency through aggregation of purchasing volume, and through using this leverage to negotiate discounts with manufacturers, distributors and other vendors.

GPOs are commonly owned by the healthcare providers themselves. GPOs (even in non-healthcare related fields) are ultimately responsible to their provider members or owners. Typically, contract decisions for the GPO are made in committee settings, in which the committees help to determine which products are most appropriate from a clinical point of view. The GPOs then negotiate the appropriate contracts. Following negotiation, healthcare providers can then buy through a GPO or directly from a manufacturer.

In addition to the value of conventional group purchasing, which provides aggregated buying power to obtain volume discounts, GPOs provide comprehensive clinical reviews, streamline and standardize the purchasing process, lower product prices, and typically promote competition. Commonly, such GPOs are financed by administrative fees and the like.

In the healthcare marketplace, in particular, GPOs are commonly funded by vendor-paid administrative fees, which allow providers to dedicate more financial resources to the direct administration of patient care. This practice came to prominence in 1986 and 1987, when the United States Congress passed legislation which allowed GPOs to earn administrative fees from suppliers as an alternative to requiring hospitals to fund all costs associated with running a GPO. In 1991, the Department of Health and Human Services (HHS) issued final regulations regarding these issues.

The so-called “GPO Safe Harbor” does not cap the amount of vendor paid administrative fees, rather it requires fees over 3% to be fully disclosed to the GPO's hospital members, and the HHS has the authority to request such information. Fees are generally based upon the purchase price that the provider pays. The fee is only paid when a GPO's provider-member utilizes a contract.

Rebates are negotiated by GPOs to be paid to providers, and the major benefit of the traditional GPO model is that providers can dedicate captured financial resources to the administration of healthcare. A conventional prior art GPO methodology for healthcare services is illustrated in FIG. 3. As shown, a GPO 40 is funded by membership dues from a hospital (or other healthcare service provider) 44, and from administration fees (typically taken from a percentage of sales) taken from a manufacturer or supplier of medical-related goods and services 46. The GPO 40 negotiates an agreement for the price of these goods and services with the manufacturer 46, and distributes surplus funds to the hospital 44, which may constitute a member of the GPO.

The hospital 44 must pay additional distributor fees to the healthcare goods and services distributor 48, and also separately negotiate a contract for the price of these goods and services. The distributor 48, in turn, negotiates a so-called dealer-into-stock price with the manufacturer or provider 46, and receives a debit or deduction from the manufacturer, commonly referred to as a “chargeback”. The GPO 40, the hospital 44, the manufacturer 46 and the distributor 48 must all negotiate together for a central agreement for the distributor fees (shown at 42). Such a system is, obviously, highly inefficient, particularly as there is no central management of the negotiation and flow of fees.

Further, it should be noted that traditional GPOs are in decline in terms of attaining greater market share due to increased regulatory scrutiny, members challenging the value of GPOs, and the diminishing ability of gaining member compliance with contracts. The trading partners of the GPOs are presently seeking ways to increase their market share, however, as of yet, they are not pursuing an employer-based business methodology, as is described by the instant invention.

Further, numerous studies have pointed out that increases in wage and salary costs for employers increased from the 1970s to the 1990s while the cost of health care benefits increased dramatically over the same time period. According to the Employee Benefit Research Institute (EBRI), of the three major employee benefit categories, health benefits increased the most as a percentage of benefit spending. In 1950, health benefits accounted for 8.8 percent of all benefit spending, retirement benefits 56.3 percent, and other benefits 33.8 percent. By 2004, health benefits accounted for 43.2 percent of all benefit spending, retirement benefits 47.1 percent, and other benefits 9.8 percent.

Until recently, large employers have not focused on direct input prices for health care supply chain costs. Presently, this trend is beginning to change. As an illustrative example, General Motors (GM) is presently the largest private provider of health insurance in the U.S. For many years, GM has aggressively sought to reduce its health care costs by encouraging its employees and retirees to switch health care providers as well as products.

GM has recently initiated a program to move its employees from brand-name statins to newly available generic versions of Merck's Zocor®. Generic Zocor® tablets are priced at about 90 cents each, compared with $3.33 per pill for Pfizer's Lipitor®. GM currently spends $200 million dollars annually for cholesterol drugs for its employees.

GM's expenditures could be reduced by 59%, to $82 million, if the 250,000 GM employees presently taking cholesterol medications switch to the generic option. If GM and other employers and insurers continue this trend, by substituting generic drugs for the 70 brand-name drugs which will have patents which will expire within five years, total savings could reach approximately $49 billion by the year 2011. Such switches also could reduce employees' out-of-pocket payments for prescription drugs. A managed employer-based cooperative, as described by the instant inventive method can contribute to employers' objectives of achieving healthcare savings without compromising quality of care or overburdening employees.

Presently, of all the participants in the traditional healthcare purchasing supply chain (manufacturers, distributors, providers, etc.), it is the private sector employers that have the least power and control over supply chain costs. The present inventive business method allows for private sector employers to negotiate directly with healthcare-related providers and distributors, thus placing greater negotiating and financial power with the employers themselves. Rather than negotiating through third-parties, as is presently performed in the GPO business method, and other similar methodologies, employers under the inventive method may receive timely, accurate data about the dynamics of the healthcare supply chain, which are necessary for cost-effective negotiating decisions.

The prior art healthcare systems, as described above, have previously created cooperatives, but these organizations have typically been for the benefit of health care providers alone, not for employer members. These entities have typically been narrowly focused on their own agendas, and have not provided the full range of benefits to their members. The present inventive method, in contradistinction, supplies the employer membership with transparent and accurate information about supply chain costs, and the established cooperative magnifies the employers' ability, through incentive payments to providers, to move significant market share toward the cooperative and the book of vendor contracts it would manage.

None of the above methodologies, taken either singly or in combination, is seen to describe the instant invention as claimed. Thus, a method for managing and providing healthcare solving the aforementioned problems is desired.

### SUMMARY OF THE INVENTION

The business method of managing and providing healthcare includes the formation of a centralized management organization for managing and organizing at least one group purchasing cooperative (GPC), formed from a plurality of members. As opposed to the conventional GPO business model, as described above, the at least one group purchasing cooperative is preferably composed of private sector employers (or those who may represent the employers), allowing the employers to negotiate for healthcare directly, without the inefficiencies, as described above, of the multi-level GPO purchasing and negotiation methodology. The employer-owned cooperative contracts directly with healthcare device and pharmaceutical manufacturers in return for volume-related discounts, exclusive price and utilization information, vendor-paid patronage dividends to the owners of the cooperative, and the ability to move market share. By directly negotiating with the healthcare manufacturers and distributors, the employers gain negotiating information previously withheld from them via prior art methodologies. With information about supply chain costs and efficiencies, the employer cooperative gains the ability to offer incentives to healthcare providers in order to move significant market share toward the cooperative and the book of vendor contracts it manages. The management organization and the cooperative are customized to complement the work of the employer owners.

Data and information related to the plurality of members is stored and organized via a computerized system, such as a computerized database or the like, and the group purchasing cooperative negotiates contracts directly with healthcare-related manufacturers and distributors for healthcare-related goods and services. Following this method, information related to the healthcare-related goods and services is provided directly to the GPC, rather than through second or third-hand parties, and fees for second or third-hand parties, such as those described in the prior art GPO methodology, are either reduced or transferred back into the GPC. Further, discounts and rebates can be negotiated directly with the GPC, once again allowing for reduced overall fees which, under the GPO methodology, would go to parties other than the members of the GPC.

Following negotiation, the goods and services may then be provided directly the members of the group purchasing cooperative. Further, the management organization may assemble a collection, or “book” of healthcare-related contracts, to be used in future negotiations, and this collection may be stored and organized by the computerized means. Transactions and communications may further be computerized through the use of e-mail, electronic financial transfers and the like.

The management organization controlling the cooperative endeavors to improve the quality of health services provided to employees and generally reduce health care costs; improve the financial outlook of employers relative to healthcare expenditures; create value for cooperative owners; enhance the quality of information about health care costs; secure transparency of supply chain costs; act as the advocate for the employers financial interests; facilitate knowledge transfer of supply chain costs and issues; and, grow the cooperative enterprise to achieve effectiveness and efficiency.

These and other features of the present invention will become readily apparent upon further review of the following specification and drawings.

### BRIEF DESCRIPTION OF THE DRAWINGS

FIG. 1 is a block diagram showing the business method of managing and providing healthcare according to the present invention.

FIG. 2 is a flow diagram of the steps of the business method of managing and providing healthcare according to the present invention.

FIG. 3 is a block diagram illustrating a prior art group purchasing organization business methodology.

FIG. 4 is a block diagram illustrating the business method of managing and providing healthcare according to the present invention.

Similar reference characters denote corresponding features consistently throughout the attached drawings.

### DETAILED DESCRIPTION OF THE PREFERRED EMBODIMENTS

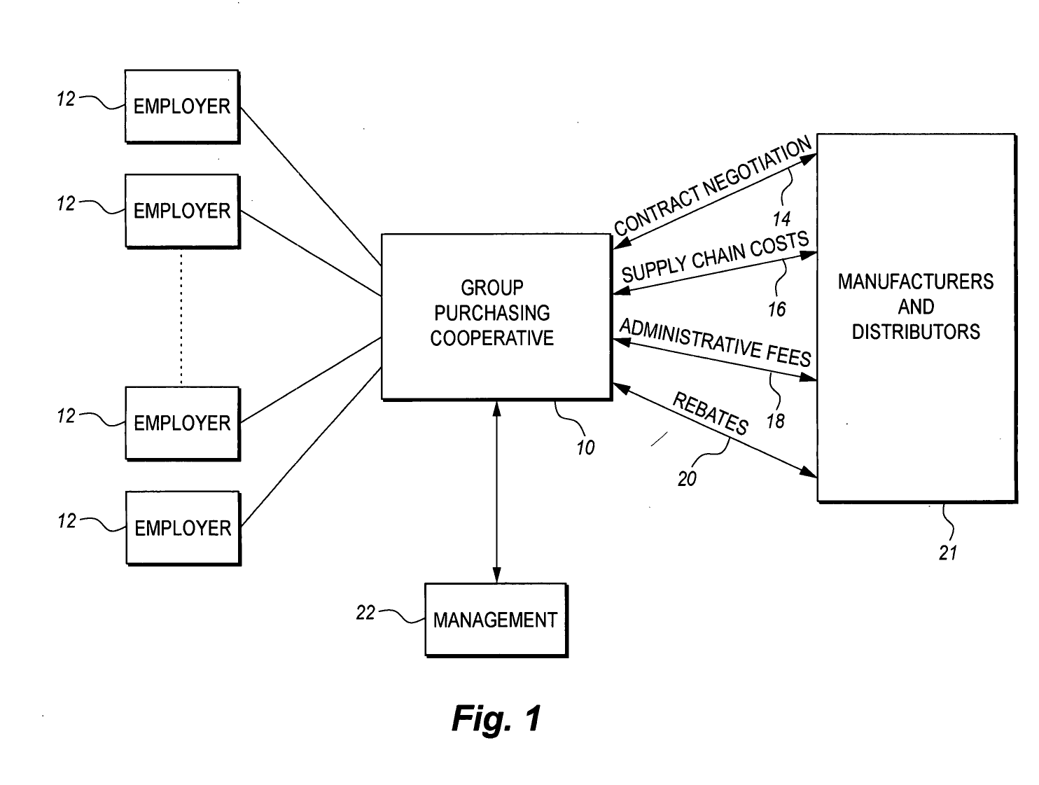

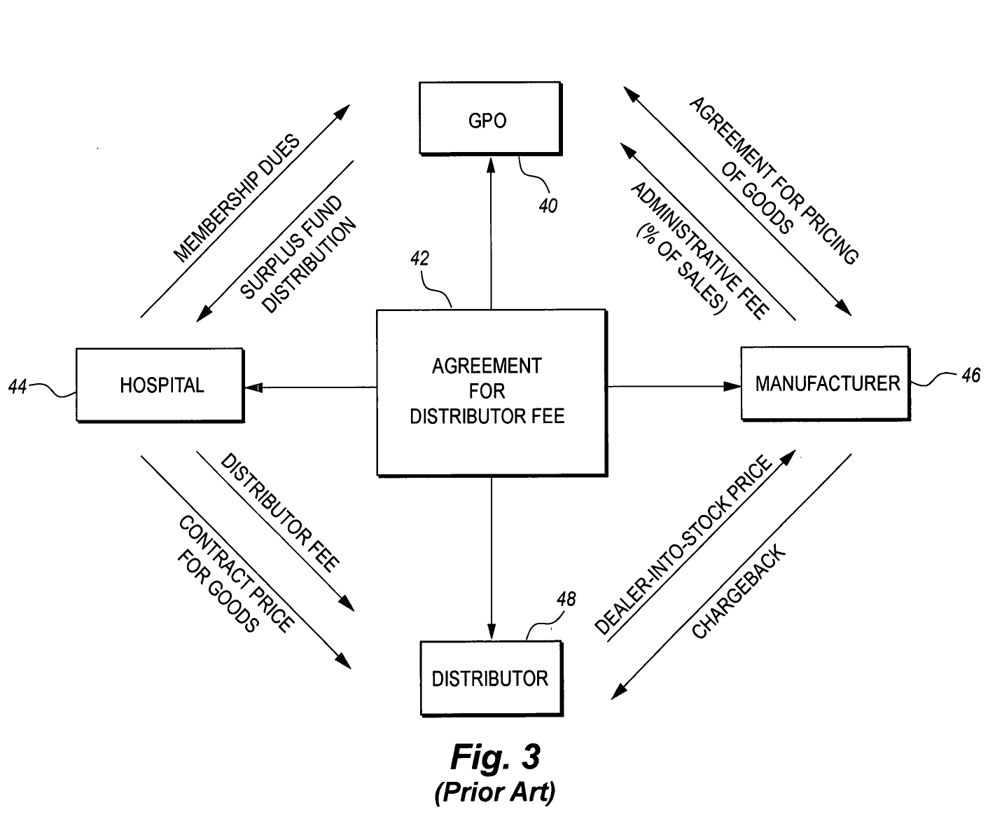

The business method of managing and providing healthcare includes the formation of a centralized management organization for managing and organizing at least one group purchasing cooperative (GPC), formed from a plurality of members. An overview of the method is shown in FIG. 1. As opposed to the prior art conventional GPO business model, as described above and shown in FIG. 3, the at least one group purchasing cooperative 10 is preferably composed of private sector employers 12, allowing the employers to negotiate for healthcare directly, without the inefficiencies, as described above, of the multi-level GPO purchasing and negotiation methodology of FIG. 3. It should be understood that others may form the membership of the group purchasing cooperative, however, in the preferred embodiment, the group purchasing cooperative is formed from members who are employers, or who represent business employers.

Data and information related to the plurality of members is preferably stored and organized via a computerized system, such as a computerized database or the like, and the group purchasing cooperative 10 negotiates contracts directly with healthcare-related manufacturers and distributors 21 for healthcare-related goods and services. The management organization 22 oversees, manages and organizes the formation of the group purchasing cooperative 10, and further oversees the negotiations, financial transactions and other business matters related to the group purchasing cooperative 10. The management organization 22 further maintains and organizes the records of the business transactions, preferably on a computerized database system or the like.

In the conventional prior art GPO method shown in FIG. 3, negotiation takes place between the hospital 44 and the distributor 48, between the GPO 44 and the manufacturer 46, and between all four entities 40, 44, 46 and 48 for distributor fees. As shown in FIG. 1, the multi-party, inefficient system of FIG. 3 is replaced by direct negotiation of contracts 14 between the group purchasing cooperative 10 (managed by management organization 22) and the manufacturers and distributors 21. Similarly, supply chain costs 16, administrative fees 1 8 and rebates 20 and handled directly between the GPC 10 and the manufacturers and distributors 21.

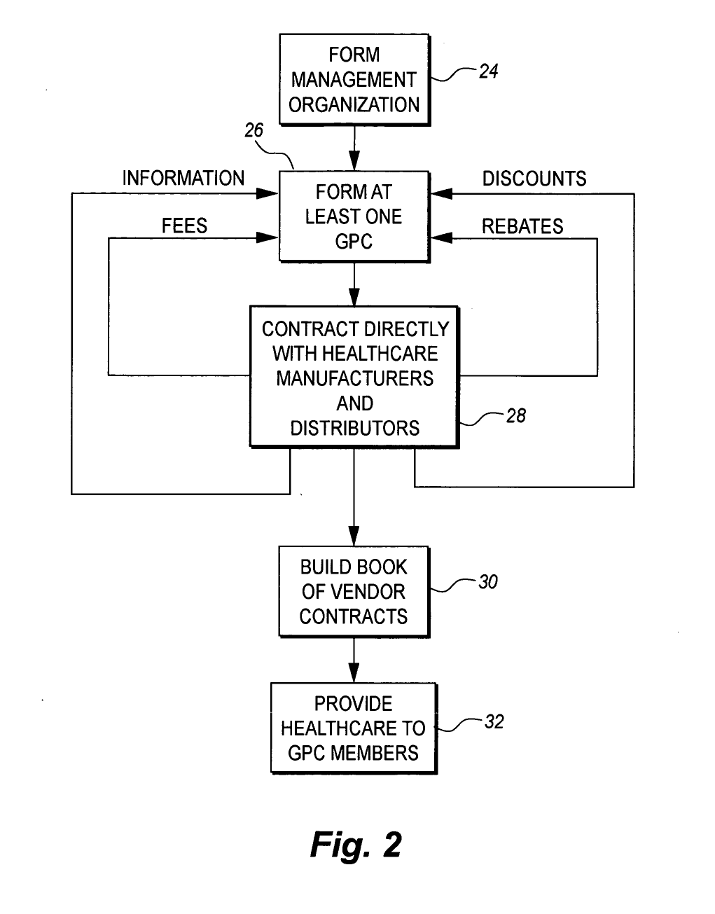

As best shown in the flow diagram of FIG. 2, once the management organization is formed (at step 24), at least one GPC is formed and managed by the management organization (at step 26). Though FIG. 1 illustrates only a single GPC being formed and managed by management organization 22, it should be understood that management organization may form and manage any number of GPCs, dependent upon the needs and desires of the management organization and the members of the GPCs. At step 28, the GPC (under the management of the management organization) directly negotiates contracts with the healthcare-related manufacturers and distributors. As noted above, negotiations may include electronic communications via e-mail or the like, and records of the negotiations may be stored and organized electronically, using any suitable computerized methods or means.

Following the inventive method of FIG. 2, information related to the healthcare-related goods and services is provided directly to the GPC, rather than through second or third-hand parties, and fees for second or third-hand parties, such as those described in the prior art GPO methodology of FIG. 3, are either reduced or transferred back into the GPC. Further, discounts and rebates can be negotiated directly with the GPC, once again allowing for reduced overall fees, which, under the prior art GPO methodology, would go to parties other than the members of the GPC.

Following negotiation, the goods and services may then be provided directly the members of the group purchasing cooperative (step 32). Further, the management organization may assemble a collection, or “book” of healthcare-related contracts (step 30), to be used in future negotiations, and this collection may be stored and organized by the computerized means. Transactions and communications may further be computerized through the use of e-mail, electronic financial transfers and the like.

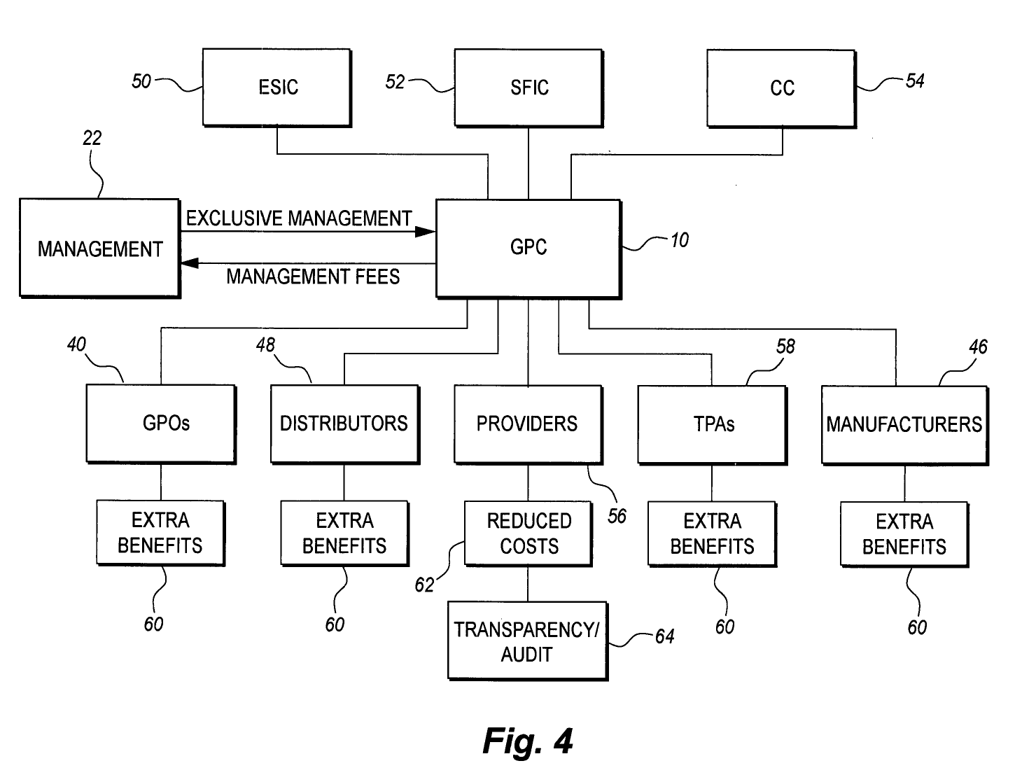

As seen in FIG. 4, GPCs may be formed from members consisting of employer-sponsored insurance companies (ESIC) 50, self-funded insurance companies (SFIC) 52, and subsidiaries owned by a parent corporation, or so-called “captive companies” (CC) 54. It should be understood that other groups may constitute membership in the GPCs, and that the above groups are given for exemplary purposes only. The management organization 22 preferably provides exclusive management and organization for the GPC(s) 10 and is funded through management fees, charged to the GPC(s) 10.

Typically, in an ESIC, the employer pays a set amount to the insurer. Anything above that amount, the insurer will pay. This protects the employer from unexpected high health care costs. If there is any profit after the insurer pays all claims, the insurer keeps it. Essentially, the employer is transferring the risk of monetary loss due to medical costs to the insurer for a fee. How much the employer pays is its gamble on how much it thinks its employees will amass in medical costs. In SFICs, the employer sets aside a certain amount that it thinks will cover medical costs for its employees. This money will be paid out in claims, and if there is any profit, the employer will keep it, thus making self-funding a lucrative option as well as creating incentives to keep health care costs down. The employer may use a captive company as a vehicle for self-insurance. Because there is a substantial risk of unforeseen high individual claims and high claim activity, the employer may choose to purchase stop-loss coverage. The employer then has the advantage of tailoring the plan and benefits to its employees' needs.

Self-funded insurance has its disadvantages, though. Despite stop-loss coverage, employers may still experience unexpected costs: fluctuations in claim costs, higher deductible charges from re-insurers for seriously ill employees, and higher hospital and physician costs due to the absence of provider-insurer price negotiations. Typically, larger companies have been the ones to implement self-funded insurance. However because of unmanageable increases in health care premiums, many small companies—with as little as 80 workers—are switching to self-funding. All of these groups may join the GPC and are seen as target markets for the GPC methodology, though it should be understood that any suitable members may be organized by the management organization and formed into one or more GPCs.

As described above, the GPC 10 may then contract directly with distributors 48, providers 56 and manufacturers 46, providing extra benefits 60 (as described above with regard to FIGS. 1 and 2) to the GPC (compared to the traditional GPO model), reduced costs 62, and financial “transparency” (i.e., all financial transactions are handled directly through the GPC and the target companies, thus removing second and third-hand parties, who may confuse data and make a financial audit difficult or impossible). Further, the GPC 10 may also contract directly with GPOs 40 or other groups or businesses involved in a trading partner agreement (TPA) with the GPC 10.

Under the prior art GPO model, no single entity exists to serve employers which can manage contract negotiations, control supply chain costs, and re-capture administrative fees and rebates (which are paid just to the providers in the GPO method). Under the present inventive method, management organization 22 allows for direct contract negotiations and recapture of fees for the GPC. Further, the GPC enhances the employers' ability, through the establishment of incentive payments to providers, to move significant market share toward the GPC and the book of vendor contracts the GPC and management organization manage.

The GPC model of the present invention creates employer-owned medical device purchasing cooperatives dedicated to the reduction of the members' healthcare expenditures. Through the cooperatives, employer members will be able to exert tremendous influence over product selection, specifically as it pertains to clinically preferred, high cost implantable devices and the like. By applying critical utilization information, the GPC and management organization will assist employer cooperative members in developing strategies with targeted device manufacturers to extract deep product discounts based on shifting market share for their devices.

Further, the employers will be able to ensure that their covered employees are receiving implantable devices, for example, of the highest quality while receiving product discounts and manufacturer rebates on an expanding book of purchase contracts that were previously available only to hospitals and other purchasing organizations. Further, employer members will participate in the financial success of the cooperative.

The formation of management organization 22 is the first step in the method illustrated in FIG. 2 (step 24). Individual employers dealing with employee healthcare issues may have difficulties in developing an infrastructure and proper staff to aid in making purchasing decisions, building enough business “clout” or leverage to be able to negotiate directly with manufacturers and distributors, and also applying the proper business and monitoring techniques which are necessary for efficient and effective dealings with the manufacturers and distributors. The management organization which forms the GPC 10 will be able to provide for all of these business and management-related issues, and further acts as a centralized nexus for forming and controlling one or more GPCs. Such a centralized system is presently lacking in the prior art GPO-based systems.

It is to be understood that the present invention is not limited to the embodiments described above, but encompasses any and all embodiments within the scope of the following claims.

I claim:

1. A business method of managing and providing healthcare, comprising the steps of:
forming a management organization;
forming at least one group purchasing cooperative, said at least one group purchasing cooperative being managed by said management organization and being formed from a plurality of members;
providing computerized means for data storage and organization;
organizing and storing data associated with said plurality of members through said computerized means;
negotiating healthcare-related contracts directly with healthcare manufacturing and distribution services for healthcare-related goods and services; and,
providing the contracted healthcare-related goods and services to the members of said at least one group purchasing cooperative.

2. The business method of managing and providing healthcare as recited in claim 1, further comprising the step of assembling a collection of healthcare-related contracts.

3. The business method of managing and providing healthcare as recited in claim 2, further comprising the step of organizing and storing the collection of healthcare-related contracts through said computerized means.

4. The business method of managing and providing healthcare as recited in claim 3, wherein said step of negotiating healthcare-related contracts includes negotiation of supply chain costs.

5. The business method of managing and providing healthcare as recited in claim 4, wherein said step of negotiating healthcare-related contracts includes negotiation of administrative fees.

6. The business method of managing and providing healthcare as recited in claim 5, wherein said step of negotiating healthcare-related contracts includes negotiation of rebates provided to the at least one group purchasing cooperative from the healthcare manufacturing and distribution services.

7. The business method of managing and providing healthcare as recited in claim 1, wherein said step of forming at least one group purchasing cooperative includes selection of the plurality of members from employers.

8. The business method of managing and providing healthcare as recited in claim 1, wherein said step of forming at least one group purchasing cooperative includes selection of the plurality of members from the group consisting of: employer-sponsored insurance companies, self-funded insurance companies, and subsidiaries owned by a parent corporation.

9. A business method of managing and providing healthcare, comprising the steps of:
forming a management organization;
forming at least one group purchasing cooperative, said at least one group purchasing cooperative being managed by said management organization and being formed from a plurality of members;
establishing an initial monetary fund provided by said plurality of members;
negotiating healthcare-related contracts directly with healthcare manufacturing and distribution services for healthcare-related goods and services, said healthcare-related contracts including a set price for said healthcare-related goods and services and a negotiated discount;
transferring payment to said healthcare manufacturing and distribution services from said initial monetary fund, said payment calculated as the set price minus the negotiated discount;
defining a surplus monetary fund as the remainder of money following said step of transferring payment; and,
providing the contracted healthcare-related goods and services to the members of said at least one group purchasing cooperative.

10. The business method of managing and providing healthcare as recited in claim 9, further comprising the step of paying management fees to said management organization, said management fees being transferred from said initial monetary fund.

11. The business method of managing and providing healthcare as recited in claim 9, further comprising the step of paying management fees to said management organization, said management fees being transferred from said surplus monetary fund.

12. The business method of managing and providing healthcare as recited in claim 9, wherein said step of forming at least one group purchasing cooperative includes selection of the plurality of members from employers.

13. The business method of managing and providing healthcare as recited in claim 9, further comprising the step of assembling a collection of healthcare-related contracts.

14. The business method of managing and providing healthcare as recited in claim 13, further comprising the step of organizing and storing the collection of healthcare-related contracts through computerized means.

15. The business method of managing and providing healthcare as recited in claim 14, wherein said step of negotiating healthcare-related contracts includes negotiation of supply chain costs.

16. The business method of managing and providing healthcare as recited in claim 15, wherein said step of negotiating healthcare-related contracts includes negotiation of administrative fees.

17. The business method of managing and providing healthcare as recited in claim 16, wherein said step of negotiating healthcare-related contracts includes negotiation of rebates provided to the at least one group purchasing cooperative from the healthcare manufacturing and distribution services.

18. The business method of managing and providing healthcare as recited in claim 9, wherein said step of forming at least one group purchasing cooperative includes selection of the plurality of members from the group consisting of: employer-sponsored insurance companies, self-funded insurance companies, and subsidiaries owned by a parent corporation.
